(19) United States
(12) Patent Application Publication
(10) Pub. No.: US 2026/0188634 A1
(43) Pub. Date: Jul. 2, 2026

(54) MASS SPECTROMETRY APPARATUS

(71) Applicant: BIOMERIEUX INC., Durham, NC (US)

(72) Inventor: Kevin Michael HAYDEN, Newton, NH (US)

(21) Appl. No.: 19/005,787

(22) Filed: Dec. 30, 2024

(51) Int. Cl. H01J 49/02; H01J 49/16

(52) U.S. Cl. CPC H01J 49/025; H01J 49/164

(57) ABSTRACT

A ion detector for a mass spectrometry apparatus is disclosed. The ion detector comprises: a microchannel plate (MCP), a scintillator, and a photomultiplier (PMT), the MCP comprising a MCP assembly and an isolation part fixed to the MCP assembly, the MPC assembly being configured to convert ions into electrons, the scintillator being configured to convert electrons into light, and the photomultiplier being configured to convert the light into an electrical signal. The isolation part of the MCP comprises at least one element, called isolation element, made of ceramic.

### FIELD OF TECHNOLOGY

The present technology relates to mass spectrometry and diagnostic tools in the field of In Vitro Diagnostics.

### BACKGROUND

Mass spectrometry has become one of the preferred diagnostic tools in the field of In Vitro Diagnostics. This is primarily due to speed accuracy and specificity critical for patient care. The introduction of this technology into IVD allows for time sensitive targeted treatments caused by bacterial infections, viral infections, and other types of diseases.

Linear MALDI-TOF (matrix assisted laser desorption time of flight) are the preferred mass spectrometers used for IVD applications primarily because their simplicity as well as being suitable for the properties of the molecules being analyzed. For example, the TOF linear analyzer is ideal for analyzing high mass ions such as intact proteins.

Up until recently widespread acceptance of MALDI-TOF spectrometry has been limited by factors including cost, reliability, speed, sensitivity, mass accuracy and resolution. Technological advancements in lasers, ion sources and mass analyzers have dramatically improved speed, performance, and cost. High through put MALDI-TOF mass spectrometers capable of acquisition rates up to 5 Khz are now commonplace at an affordable price.

The ion detector is an essential component for any mass spectrometer. The function of the detector is converting ions generated by the ion source into electrical signals that can be recorded or counted. High throughput applications including but not limited to clinical, tissue imagining and protein spectral profiling, rely on detector stability. This is critical in generating measurable signals for extended durations of operation.

However, a situation may exist in which the ion detector and, hence, the mass spectrometer, is less efficient over time.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches.

### SUMMARY

It is an object of the present technology to ameliorate at least some of the inconveniences of the prior art.

In a first broad aspect of the present technology, there is provided a ion detector comprising: a microchannel plate (MCP), a scintillator, and a photomultiplier (PMT), the MCP comprising a MCP assembly and an isolation part fixed to the MCP assembly, the MPC assembly being configured to convert ions into electrons, the scintillator being configured to convert electrons into light, and the photomultiplier being configured to convert the light into an electrical signal. The isolation part of the MCP comprises at least one element, called isolation element, made of ceramic.

In some non-limiting implementations, said isolation element is a mounting standoff.

In some non-limiting implementations, the ceramic comprises Al₂0₃.

In some non-limiting implementations, the ceramic comprises with a purity higher than 95%, preferably 98% or 99, 8%.

In some non-limiting implementations, the apparatus comprises a voltage divider to supply power to the MCP, said voltage comprising a resistor connected in series to the MCP, said resistor being printed on an external surface of the isolation element.

The invention also relates to a mass spectrometry apparatus comprising a ion detector as previously described.

In some non-limiting implementations, the apparatus comprises a ionization stage.

In some non-limiting implementations, the ionization stage is of a matrix assisted desorption time of flight (MALDI-TOF) type.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

These and other features, aspects and advantages of the present technology will become better understood with regard to the following description, appended claims and accompanying drawings where:

FIG. 1 is a schematic functional view of three stages of a ion detector for a mass spectrometry apparatus of the present technology;

FIG. 2 is a schematic view of an electric potential diagram in the ion detector of FIG. 1;

FIG. 3 is a schematic view of a voltage divider for supplying power to a microchannel plate (MCP) of the ion detector of FIG. 1;

FIG. 4 is a side view of the ion detector of FIG. 1 according to a first embodiment of the present technology;

FIG. 5 is a side view of the ion detector of FIG. 1 according to a second embodiment of the present technology;

FIG. 6 is a perspective view of a resistor of the voltage divider of FIG. 3;

FIG. 7 illustrates a comparison between the performance over time of a detector of the prior art and the performance of the detector of FIG. 5; and

FIG. 8 is a graphic showing another comparison of the performance of a detector of the prior art and detectors according to the first and the second embodiments of the present technology.

It should also be noted that, unless otherwise explicitly specified herein, the drawings are not to scale.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements that, although not explicitly described or shown herein, nonetheless embody the principles of the present technology.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative systems embodying the principles of the present technology.

As can be seen from the figures, the present technology relates to a ion detector 1 for a mass spectrometer. The present technology also relates to a mass spectrometer comprising the ion detector 1. According to some non limiting embodiment, the mass spectrometer is based on a MALDI-TOF method.

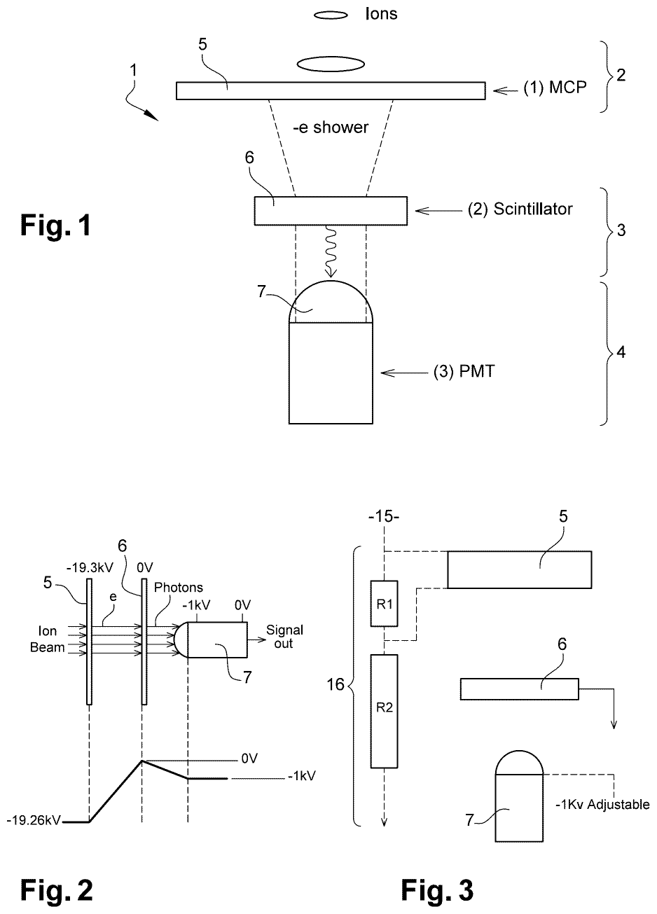

The ion detector 1 comprises three gain stages, as shown on FIGS. 1, 2, and 3. The first stage is a microchannel plate (MCP) stage 2. The second stage is a scintillator stage 3. The third stage is a photomultiplier (PMT) stage 4.

The MCP stage 2 comprises a MCP assembly 5 configured to convert ions into electrons. The scintillator stage 3 comprises a scintillator 6 configured to convert the electrons from the MCP assembly 5 into light. The PMT stage 4 comprises a photomultiplier tube 7 configured to convert the light from the scintillator 2 into an electrical signal. In other words, the PMT tube 7 detects the flashes of light from the scintillator 6 and converts them into an amplified electrical signal.

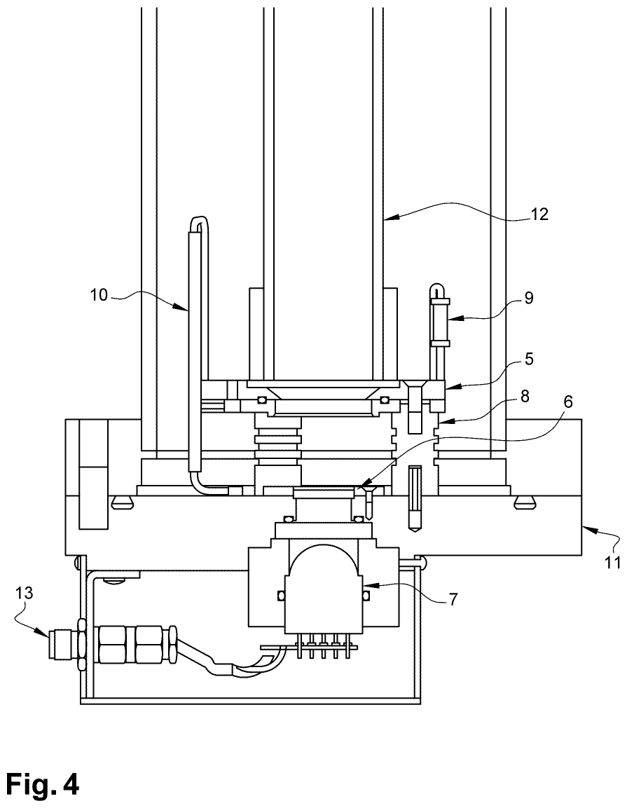

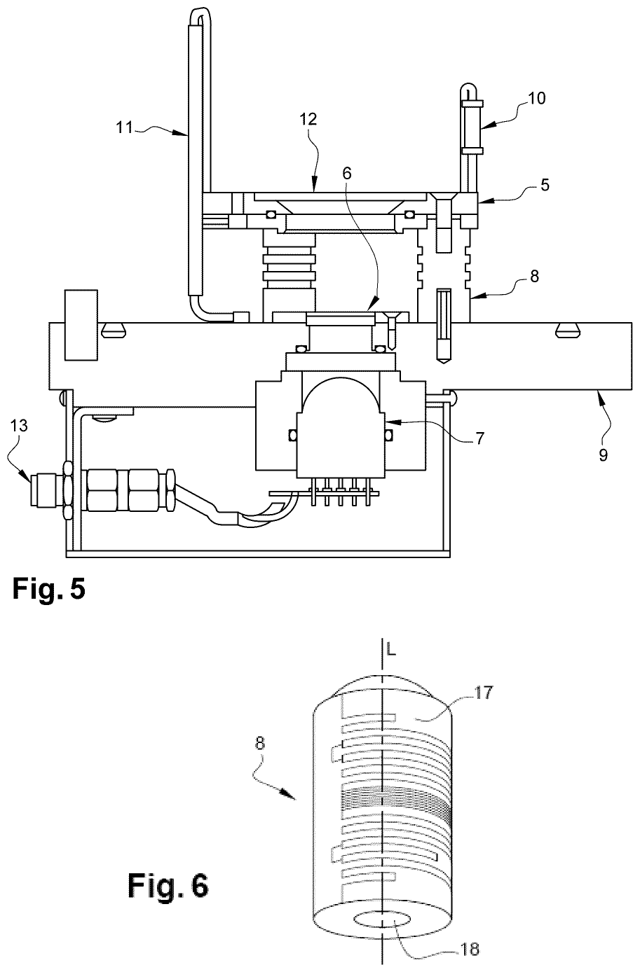

FIGS. 4 and 5 show different non limitative embodiments of the ion detector 1. As can be seen from these figures, the ion detector 1 comprises mounting standoffs 8 fixed to the MCP assembly 5. The ion detector 1 also comprises a detector base flange 9, a MCP bias resistor 10, a MCP load resistor 11, an accelerator high voltage input 12, a detector signal output and PMT input voltage 13.

At least one mounting standoff 8 is made of ceramic. In an embodiment, all the mounting standoffs 8 are made of ceramic. The ceramic materials present good dielectric isolation as well as good thermal conductivity. The ceramic can comprise Al₂O₃, with a purity of or higher than 95%, for instance 98% or 99,5% depending on the hardness and electrical isolation and thermal conductivity that are needed. The ceramic can comprise 55% fluorophlogopite mica and 45% borosilicate glass, as sold for instance under the reference MACOR®.

While maintaining good electrical isolation, the ceramic mounting standoffs 8 optimize the evacuation of heat from the MCP assembly 5, which improves the thermal stability of the MCP stage 2.

The MCP assembly 5 is constructed of leaded glass and can be configured with various surface coatings to enhance kinetic electron emissions. The temperature across the MCP can dramatically change over long durations of operation. In the prior aet, there is no proper thermal management and temperatures can deviate up to 200° C. which can have a significant impact on MCP's performance. The use of ceramic that have good thermal conductance and high dielectric properties ensures the thermal stability of the MCP assembly 5.

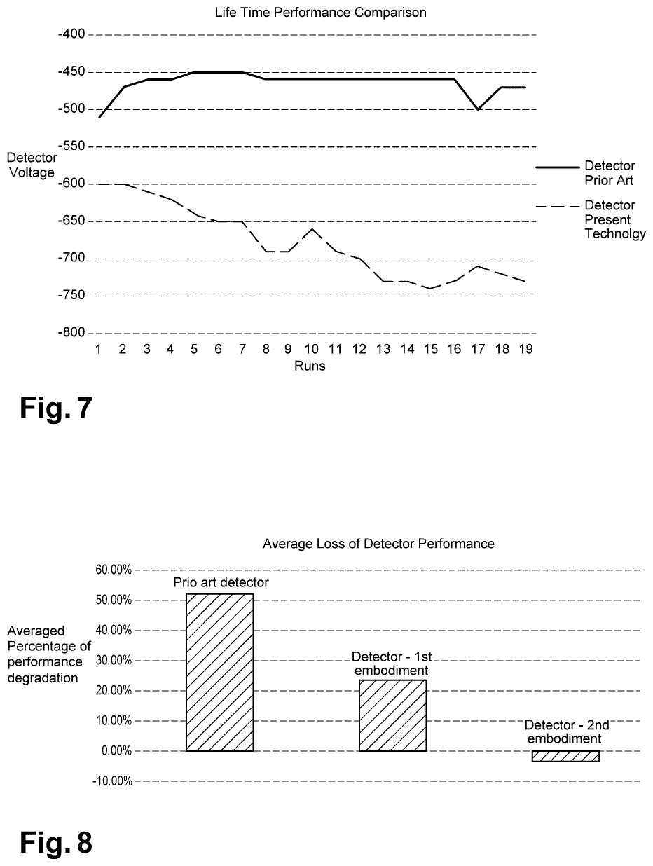

The ion detector 1 ensures that the gain of the mass spectrometer apparatus reduces as little as possible over time, as will be detailed in reference to FIGS. 7 to 9, thus extending the life of the mass spectrometer apparatus.

As can be seen from FIG. 2, the electrical potential changes along the three stages of the ion detector 1. The MCP stage 2 is for example at −20 kV (−19.26 kV on FIG. 2) then increases to reach 0 in the scintillator stage 3 before decreasing to −1 kV at the output of the PMT 4. Please note that the potential applied to each stage is not limited to the one of the embodiments that are illustrated on the figures but can differ, depending on the structure of the mass spectrometer, the samples that are being tested, for example.

The MCP stage 2 is being operated under high vacuum to apply the −20 kV potential and the potential is applied by successive levels. When a given level is reached, the pressure in the ion detector 1 first increases, because of degassing, until it reduces and stabilizes. Then, the next level of potential can be applied. The waiting time between the two levels is drastically reduced with the ion detector 1, while it can take hours with ion detectors of the prior art.

As can be seen from FIG. 3, the ion detector 1 comprises a high power supply 15 to supply power, of voltage V, to the MCP assembly 5, as well as a voltage divider 16 with resistors R1 and R2, such that the voltage of the MCP assembly 5 is R1/(R1+R2)V.

Said differently, the input potential to the MCP assembly 5 is supplied through the high voltage divider network 16. The fixed bias potential across the MCP is determined by Resistor R1. Resistor R2 provides the high voltage dropping potential from the rear of the MCP to ground providing the electrons exiting the back of the MCP enough impact energy to be converted to flashes of light down steam at the scintillator. The Scintillator is referenced to ground. In FIG. 3, the PMT is the only adjustable gain stage of the detector with an operating range from 0 to −1 Kv.

According to one embodiment, the mounting standoff 8 can be a cylinder 17 with a central hole 18 that extends along a longitudinal axis L of the cylinder.

According to an alternative shown in FIG. 6, the ceramic mounting standoff 8 also comprises resistor R2. Resistor R2 s printed on an external surface 19 of the cylindrical mounting standoff 8. The ceramic of the standoff 8 ensures good evacuation of heat from resistor R2, which implies an optimized use of resistor R2 and a longer life of the voltage divider 16.

There are now detailed tests conducted by the Applicant to compare a MALDI-TOF mass spectrometer with ion detector 1 to a MALDI-TOF mass spectrometer with an ion detector from the prior art.

E. coli ATCC 8739 was used for all the testing. 1 ul loop of E. coli, ATCC 8739 (incubated 18 h-24 h maximum on CBA medium in incubator type 36° C.) was transferred in 90 ul of CHCA matrix (Biomerieux Vitek® MS CHCA) and vortexed for 2 minutes. 1 ul droplet of the suspension was deposited onto each of the 48 sample and 3 reference spot locations on a single sample slide. This was repeated for every slide processed through the testing cycle.

The potential diagram that is followed during the testing is the one of FIG. 2. The ion detector structure used for the testing is mainly the one of FIGS. 4 and 5. The mounting standoffs differ nonetheless: for testing prior art ion detector, the mounting standoffs are in plastics (Techtron® PPS plastic standoffs—test 1). For testing ceramic mounting standoffs ion detector 1, there have been used two types of standoffs 8. The first one is a Al203 99.8% ceramic standoffs with a conventional resistor (test 2). The second one is a Al203 99.8% ceramic standoffs with a resistor R2 printed on the external surface of the standoff (test 3). The value of resistor R2 is 540 MΩ for each standoff.

The Applicant led experiments to compare the performance of the detector of the second embodiment of the present technology to the performance of the detector of the prior art. Performance is measured as a function of the detector operating voltage that is necessary to maintain the same detector gain for each run.

The acquisition process and experimental conditions are as follows:
an instrument acquisition system was setup to acquire a maximum of 1.03 M Acquisitions/Sample spot, approximately 53 Million acquisitions per sample slide;
criteria for accepting acquisitions are that the ion signal intensity must be higher 15 mv between a mass range of 2 Kda-12 Kda;
19 slides were acquired for each detector configuration;
the detector voltage was set before each test;
criteria for establishing the correct operating voltage that corresponds to a detector gain of 1.2e6 producing a single ion intensity of 50 mv;
single acquisition (1 Laser shot);
acquisition Range 100 Da-25 Kda,
measure the single ion intensities between 18.5 Kda-22.5 Kda; and
adjust the detector voltage at the beginning of each acquisition until the intensities of the single ions equal 50 mv. A detector of the prior art was tested with a total of 486.731 millions acquisitions. The

detector of the present technology with resistive ceramic standoffs was tested with a total of 888.489 millions acquisitions.

As can be seen from FIG. 7, while the performance decreases over time for the detector of the prior art, the detector of the present technology has a performance that stays constant over time. In other words, the aging of the detector of the present technology is far better than the degradation of the detector of the prior art.

Another type of tests were performed. The experimental setup is the following:
Sample: E. coli ATCC 8739 was used for all the testing. 1 ul loop of E. coli, ATCC 8739 (incubated 18 h-24 h maximum on CBA medium in incubator type 36° C.) was transferred in 90 ul of CHCA matrix (Biomerieux Vitek® MS CHCA) and vortexed for 2 minutes. 1 ul droplet of the suspension was deposited onto each of the 48 sample spots and 3 reference spot locations on a single sample slide. This was repeated for every slide processed through the testing cycle.
Setting Detector Voltage:
   Detector voltage was set before each test.
   Criteria for establishing the correct operating voltage that corresponds to a detector gain of 1.2e6 producing a single ion intensity of 50 mv.
      Single acquisition (1 Laser shot);
      Acquisition Range 100 Da-25 Kda
      Measure the single ion intensities between 18.5 Kda-22.5 Kda.
      Adjust the detector voltage at the beginning of each acquisition until the intensities of the single ions equal 50 mv.
Test Acquisition
   Instrument acquisition system was setup to acquire 1.03 M Acquisitions/Sample spot, approximately 53 Million acquisitions per sample slide.
   Criteria for Accepted Acquisitions are that an ion signal intensity is higher than 15 mv between the mass range of 2 Kda-12 Kda.
   Acquisition Duration per Sample Slide is 8 hours 50 minutes.
   Instrument parameters were locked during all testing.
   Three slides were acquired for each detector configuration
Data Processing
   At the conclusion of each test all acquisitions were processed into a single 2D area chromatogram of 12 row (row A to row L) of 4 spots 1-4. The 2D output image is represented as a colored temperature map.
   Peak detection parameters used for establishing the detector voltage were identical to the ones used for all acquisitions and data processing.
   The Sum of the averaged peak areas from the first row A spots 1-4 and Row L 1-4 were converted into average number of ions.
   The difference of number of ions between Row A and Row L were compared to show the degradation of detector performance.

As can be seen from FIG. 8, comparison of the three detector configurations demonstrates that low thermal conductivity has a significant impact on long-and short-term performance on detector stability, the stability of the detector of the second embodiment being better than the stability of the detector of the first embodiment, the stability of the first embodiment being better than the stability of the detector of the prior art.

As is apparent from the previous description, the ion detector of the present technology improves the thermal stability of the MCP stage, which increases the lifetime of the mass spectrometer equipped with the ion detector of the present technology. The printed resistor improves even more the efficiency of the tool.

It will be understood that, although the embodiments presented herein have been described with reference to specific features and structures, various modifications and combinations may be made without departing from the disclosure. The specification and drawings are, accordingly, to be regarded simply as an illustration of the discussed implementations or embodiments and their principles as defined by the appended claims, and are contemplated to cover any and all modifications, variations, combinations or equivalents that fall within the scope of the present disclosure.

### CLAUSES

1. A ion detector for a mass spectrometry apparatus comprising:
   a microchannel plate (MCP),
   a scintillator, and
   a photomultiplier (PMT),
   the MCP comprising a MCP assembly and an isolation part fixed to the MCP assembly, the MPC assembly being configured to convert ions into electrons,
   the scintillator being configured to convert electrons into light, and
   the photomultiplier being configured to convert the light into an electrical signal, wherein the isolation part of the MCP comprises at least one element, called isolation element, made of ceramic.
2. The ion detector of clause 1, wherein said isolation element is a mounting standoff.
3. The ion detector of clause 1 or 2, wherein the ceramic comprises Al₂0₃.
4. The ion detector of clause 1, 2 or 3, wherein the ceramic comprises with a purity higher than 95%, preferably 98% or 99, 8%.
5. The ion detector of any of the preceding clauses, comprising a voltage divider to supply power to the MCP, said voltage comprising a resistor connected in series to the MCP, said resistor being printed on an external surface of the isolation element.
6. The ion detector of any of the preceding clauses, comprising a ionization stage.
7. A mass spectrometry apparatus, comprising a ion detector as of any of the preceding clauses.
8. The apparatus of clause 7, wherein a ionization stage is of a matrix assisted desorption time of flight (MALDI-TOF) type.

What is claimed is:

1. A ion detector for a mass spectrometry apparatus comprising:
a microchannel plate (MCP),
a scintillator, and
a photomultiplier (PMT),
the MCP comprising a MCP assembly and an isolation part fixed to the MCP assembly, the MPC assembly being configured to convert ions into electrons,
the scintillator being configured to convert electrons into light, and
the photomultiplier being configured to convert the light into an electrical signal, wherein the isolation part of the MCP comprises at least one element, called isolation element, made of ceramic.

2. The ion detector of claim 1, wherein said isolation element is a mounting standoff.

3. The ion detector of claim 1, wherein the ceramic comprises Al₂0₃.

4. The ion detector of claim 1, wherein the ceramic comprises with a purity higher than 95%, preferably 98% or 99, 8%.

5. The ion detector of claim 1 comprising a voltage divider to supply power to the MCP, said voltage comprising a resistor connected in series to the MCP, said resistor being printed on an external surface of the isolation element.

6. The ion detector of claim 1, comprising a ionization stage.

7. A mass spectrometry apparatus, comprising a ion detector that comprises:
a microchannel plate (MCP),
a scintillator, and
a photomultiplier (PMT),
the MCP comprising a MCP assembly and an isolation part fixed to the MCP assembly, the MPC assembly being configured to convert ions into electrons,
the scintillator being configured to convert electrons into light, and
the photomultiplier being configured to convert the light into an electrical signal, wherein the isolation part of the MCP comprises at least one element, called isolation element, made of ceramic.

8. The apparatus of claim 7, wherein a ionization stage is of a matrix assisted desorption time of flight (MALDI-TOF) type.
